(19) United States
(12) Patent Application Publication
(10) Pub. No.: US 2023/0145861 A1
(43) Pub. Date: May 11, 2023

(54) WATER CONDITIONING SYSTEM OF AN EDR WATER PURIFIER

(71) Applicants: CHING-HSIUNG LIN, PINGTUNG CITY (TW); KEMFLO (NANJING) ENVIRONMENTAL TECHNOLOGY CO., LTD., NANJING (CN); KEMFLO INTERNATIONAL CO., LTD., PINGTUNG CITY (TW)

(72) Inventors: ALLEN DING, NANJING (CN); XIAO-LYU HAN, NANJING (CN); EDISON FAN, NANJING (CN)

(21) Appl. No.: 17/538,416

(22) Filed: Nov. 30, 2021

(30) Foreign Application Priority Data
Nov. 11, 2021 (CN) 202111334570.0

(51) Int. Cl. C02F 1/469; B01D 61/46; B01D 61/54

(52) U.S. Cl. CPC C02F 1/4693; B01D 61/46; B01D 61/54; C02F 2201/46105

(57) ABSTRACT

A water conditioning system of an electrodialysis reversal (EDR) water purifier includes a first source water inlet, a second source water inlet, an EDR film stack, a first conductive probe, a second conductive probe, a third conductive probe, a fourth conductive probe, a variable speed pump, a one-way valve, a clean water outlet, a waste water outlet, an electrode A, an electrode B, and a control system module. With the four conductive probes detecting conductivity of water flowing through four ports on two sides of the EDR film stack and by sending detected data to the control system module, the control system module adjusts voltages of the electrode A and electrode B accordingly to instantly increase or decrease removal efficiency of the EDR film stack. Thus, the conductivity of the discharged clean water and the quality of the clean water can be stabilized.

### BACKGROUND OF THE INVENTION

### 1. Field of the Invention

The present invention relates to a water conditioning system of a water purifier, especially to a water conditioning system of an electrodialysis reversal (EDR) water purifier.

### 2. Description of the Prior Art(s)

With improvement of people's quality of life, many families have water purifiers installed in their houses, so as to ensure the safety of drinking water. However, when using the water purifier, including an electrodialysis reversal (EDR) water purifier, quality of discharged water changes according to quality of source water and purifying capacity of the water purifier. If the quality of the discharged water is not adjusted at any time, the quality of the discharged water that has been purified and tastes of water would be affected. Moreover, when brewing tea or coffee, water having a specific quality is especially required for making a good cup of tea or coffee.

A conventional way to solve the above-mentioned problem and to improve the quality of the water that has been purified is to clean an EDR film stack regularly, which is time consuming and laborious.

To overcome the shortcomings, the present invention provides a water conditioning system of an EDR water purifier to mitigate or obviate the aforementioned problems.

### SUMMARY OF THE INVENTION

The main objective of the present invention is to provide a water conditioning system of an electrodialysis reversal (EDR) water purifier. The water conditioning system includes a first source water inlet, a second source water inlet, an EDR film stack, a first conductive probe, a second conductive probe, a third conductive probe, a fourth conductive probe, a variable speed pump, a one-way valve, a clean water outlet, a waste water outlet, an electrode A, an electrode B, and a control system module.

The EDR film stack has a first inlet port, a second inlet port, a first outlet port, and a second outlet port. The first source water inlet, the first conductive probe, and the first inlet port of the EDR film stack are connected in sequence. The second source water inlet, the one-way valve, the third conductive probe, and the second inlet port of the EDR film stack are connected in sequence. The first outlet port, the second conductive probe, and the clean water outlet are connected in sequence. The second outlet port of the EDR film stack, the fourth conductive probe, and the waste water outlet are connected in sequence.

The variable speed pump has two ends connected to the third conductive probe and the waste water outlet respectively. The electrode A and the electrode B have opposite polarities and are disposed at two sides of the EDR film stack. The control system module is electrically connected with the first conductive probe, the second conductive probe, the third conductive probe, the fourth conductive probe, the variable speed pump, the electrode A, and the electrode B.

With the four conductive probes detecting conductivity of water flowing through four ports on the two sides of the EDR film stack and by sending detected data to the control system module, the control system module adjusts voltages of the electrode A and electrode B accordingly to instantly increase or decrease removal efficiency of the EDR film stack. Thus, the conductivity of the discharged clean water and the quality of the clean water can be stabilized.

Other objectives, advantages and novel features of the invention will become more apparent from the following detailed description when taken in conjunction with the accompanying drawings.

### BRIEF DESCRIPTION OF THE DRAWINGS

The FIGURE is a schematic diagram of an electrodialysis reversal (EDR) water purifier in accordance with the present invention.

### DETAILED DESCRIPTION OF THE PREFERRED EMBODIMENTS

With reference to the FIGURE, a water conditioning system of an electrodialysis reversal (EDR) water purifier in accordance with the present invention includes a first source water inlet 1, a second source water inlet 6, an EDR film stack 3, a first conductive probe 2, a second conductive probe 4, a third conductive probe 8, a fourth conductive probe 10, a variable speed pump 9, a one-way valve 7, a clean water outlet 5, a waste water outlet 12, an electrode A 18, an electrode B 19, and a control system module 20. The EDR film stack 3 has a first inlet port 14, a second inlet port 15, a first outlet port 16, and a second outlet port 17. The first source water inlet 1, the first conductive probe 2, and the first inlet port 14 of the EDR film stack 3 are connected in sequence. The second source water inlet 6, the one-way valve 7, the third conductive probe 8, and the second inlet port 15 of the EDR film stack 3 are connected in sequence. The first outlet port 16, the second conductive probe 4, and the clean water outlet 5 are connected in sequence. The second outlet port 17 of the EDR film stack 3, the fourth conductive probe 10, and the waste water outlet 12 are connected in sequence. The variable speed pump 9 is a water pump with adjustable pump rotational speed and has two ends connected to the third conductive probe 8 and the waste water outlet 12 respectively. The electrode A 18 and the electrode B 19 have opposite polarities and are disposed at two sides of the EDR film stack 3. The control system module 20 is electrically connected with the first conductive probe 2, the second conductive probe 4, the third conductive probe 8, the fourth conductive probe 10, the variable speed pump 9, the electrode A 18, and the electrode B 19.

The water conditioning system may further include an adjustable throttle 11. The adjustable throttle 11 has two ends connected with the fourth conductive probe 10 and the waste water outlet 12 respectively. The control system module 20 is electrically connected with the adjustable throttle 11. With the adjustable throttle 11, conductivity of water that flows through the waste water outlet 12 can be controlled, so as to avoid excessive conductivity of the water and to prevent the waste water outlet 12 from furring up quickly. Moreover, flow of the water that is discharged from the waste water outlet 12 can be optimized, and source water that is used to be purified can be conserved.

The water conditioning system may further include a rinsing solenoid valve 13. The rinsing solenoid valve 13 has two ends connected with the variable speed pump 9 and the waste water outlet 12 respectively. The control system module 20 is electrically connected with the rinsing solenoid valve 13. With the rinsing solenoid valve 13, the conductivity of the water that flows through the waste water outlet 12 can be controlled, so as to avoid excessive conductivity of the water and to prevent the waste water outlet 12 from furring up quickly. Moreover, the flow of the water that is discharged from the waste water outlet 12 can be optimized, and the source water that is used to be purified can be conserved.

### Embodiment

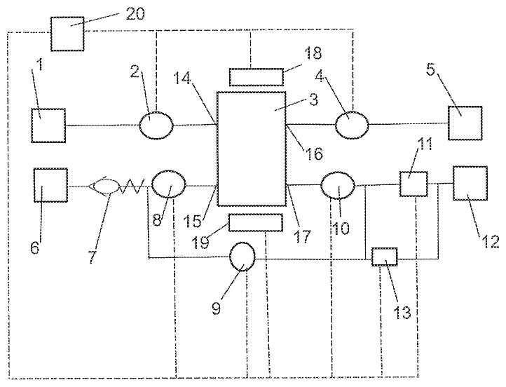

With reference to FIG. 1, a water conditioning system of an EDR water purifier in accordance with the present invention includes a first source water inlet 1, a second source water inlet 6, an EDR film stack 3, a first conductive probe 2, a second conductive probe 4, a third conductive probe 8, a fourth conductive probe 10, a variable speed pump 9, a one-way valve 7, a clean water outlet 5, a waste water outlet 12, an electrode A 18, an electrode B 19, a control system module 20, an adjustable throttle 11, and a rinsing solenoid valve 13. The EDR film stack 3 has a first inlet port 14, a second inlet port 15, a first outlet port 16, and a second outlet port 17. The first source water inlet 1, the first conductive probe 2, and the first inlet port 14 of the EDR film stack 3 are connected in sequence. The second source water inlet 6, the one-way valve 7, the third conductive probe 8, and the second inlet port 15 of the EDR film stack 3 are connected in sequence. The first outlet port 16, the second conductive probe 4, and the clean water outlet 5 are connected in sequence. The second outlet port 17 of the EDR film stack 3, the fourth conductive probe 10, and the waste water outlet 12 are connected in sequence. The variable speed pump 9 is a water pump with adjustable pump rotational speed and has two ends connected to the third conductive probe 8 and the waste water outlet 12 respectively. The adjustable throttle 11 has two ends connected with the fourth conductive probe 10 and the waste water outlet 12 respectively. The rinsing solenoid valve 13 has two ends connected with the variable speed pump 9 and the waste water outlet 12 respectively. The control system module 20 is electrically connected with the first conductive probe 2, the second conductive probe 4, the third conductive probe 8, the fourth conductive probe 10, the variable speed pump 9, the electrode A 18, the electrode B 19, the adjustable throttle 11, and the rinsing solenoid valve 13.

Working principle of the water conditioning system of the EDR water purifier is described as follows. With the four conductive probes 2, 4, 8, 10 detecting the conductivity of the water flowing through the two inlet ports 14, 15 and the two outlet ports 16, 17 and sending detected data to the control system module 20, the control system module 20 adjusts voltages of the electrode A 18 and the electrode B accordingly, so as to instantly increase or decrease removal efficiency of the EDR film stack 3. Thus, the conductivity of the discharged clean water can be stabilized and the quality of the clean water can also be stabilized. Moreover, the control system module 20 controls the adjustable throttle 11, the rinsing solenoid valve 13 according to the conductivity of the water discharged from the waste water outlet 12, so as to control the conductivity of the water discharged from the waste water outlet 12. Thus, excessive conductivity of the water discharged from the waste water outlet 12 can be avoided and the waste water outlet 12 does fur up quickly. The flow of the water discharged from the waste water outlet 12 can be optimized, and the source water that is used to be purified can be conserved.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A water conditioning system of an electrodialysis reversal (EDR) water purifier, the water conditioning system including a first source water inlet, a second source water inlet, an EDR film stack, a first conductive probe, a second conductive probe, a third conductive probe, a fourth conductive probe, a variable speed pump, a one-way valve, a clean water outlet, a waste water outlet, an electrode A, an electrode B, and a control system module, wherein
the EDR film stack has a first inlet port, a second inlet port, a first outlet port, and a second outlet port;
the first source water inlet, the first conductive probe, and the first inlet port of the EDR film stack are connected in sequence;
the second source water inlet, the one-way valve, the third conductive probe, and the second inlet port of the EDR film stack are connected in sequence;
the first outlet port, the second conductive probe, and the clean water outlet are connected in sequence;
the second outlet port of the EDR film stack, the fourth conductive probe, and the waste water outlet are connected in sequence;
the variable speed pump has two ends connected to the third conductive probe and the waste water outlet respectively;
the electrode A and the electrode B have opposite polarities and are disposed at two sides of the EDR film stack; and
the control system module is electrically connected with the first conductive probe, the second conductive probe, the third conductive probe, the fourth conductive probe, the variable speed pump, the electrode A, and the electrode B.

2. The water conditioning system of the EDR water purifier as claimed in claim 1, wherein
the water conditioning system further includes an adjustable throttle having two ends connected with the fourth conductive probe and the waste water outlet respectively; and
the control system module is electrically connected with the adjustable throttle.

3. The water conditioning system of the EDR water purifier as claimed in claim 2, wherein
the water conditioning system further includes a rinsing solenoid valve having two ends connected with the variable speed pump and the waste water outlet respectively; and
the control system module is electrically connected with the rinsing solenoid valve.
